(19) United States
(12) Patent Application Publication
(10) Pub. No.: US 2024/0113543 A1
(43) Pub. Date: Apr. 4, 2024

(54) Circuit Device And Electronic Apparatus

(71) Applicant: SEIKO EPSON CORPORATION, Tokyo (JP)

(72) Inventors: Katsumi OKINA, Fujimi (JP); Haruki KAMIKURA, Shizuoka (JP)

(21) Appl. No.: 18/475,922

(22) Filed: Sep. 27, 2023

(30) Foreign Application Priority Data
Sep. 28, 2022 (JP) 2022-154963

(51) Int. Cl. H02J 7/00; H02J 50/10

(52) U.S. Cl. CPC H02J 7/00712; H02J 50/10

(57) ABSTRACT

A circuit device includes a charging circuit, an A/D conversion circuit, a control circuit, and a linear regulator circuit. The charging circuit supplies a charging current to a battery based on a power supply voltage. The A/D conversion circuit A/D-converts a battery voltage and outputs battery voltage data. The control circuit outputs voltage control data for controlling a voltage value of the power supply voltage based on the battery voltage data such that a difference between the power supply voltage and the battery voltage is a given set voltage. The linear regulator circuit supplies the power supply voltage to the charging circuit based on the voltage control data.

The present application is based on, and claims priority from JP Application Serial Number 2022-154963, filed Sep. 28, 2022, the disclosure of which is hereby incorporated by reference herein in its entirety.

### BACKGROUND

### 1. Technical Field

The present disclosure relates to a circuit device, an electronic apparatus, and the like.

### 2. Related Art

JP-A-2003-133571 discloses a solar cell power generation system including a solar cell, a DC/DC converter, a charging circuit, a battery, a potential difference detection circuit, an error amplifier, and a duty control circuit. The charging circuit, which is a fixed resistor, is provided between an output of the DC/DC converter and the battery. The potential difference detection circuit detects a difference between a bus voltage, which is an output of the DC/DC converter, and a battery voltage, the error amplifier amplifies an error between the difference and a reference voltage, and the duty control circuit modulates a duty of switching of the DC/DC converter based on an output of the error amplifier.

A difference between an input voltage of the charging circuit and the battery voltage affects heat generation in the charging circuit and charging characteristics of the battery, and thus it is required to appropriately control the input voltage of the charging circuit. For example, in JP-A-2003-133571, the bus voltage, which is the output of the DC/DC converter, is the input voltage of the charging circuit, and it is required to appropriately control the bus voltage.

### SUMMARY

According to an aspect of the present disclosure, there is provided a circuit device including: a charging circuit configured to supply a charging current to a battery based on a power supply voltage; an A/D conversion circuit configured to A/D-convert a battery voltage, which is a voltage of the battery, and to output battery voltage data; a control circuit configured to output voltage control data for controlling a voltage value of the power supply voltage based on the battery voltage data such that a difference between the power supply voltage and the battery voltage is a given set voltage; and a linear regulator circuit configured to supply the power supply voltage to the charging circuit based on the voltage control data.

According to another aspect of the present disclosure, there is provided an electronic apparatus including the above circuit device and the battery.

### BRIEF DESCRIPTION OF THE DRAWINGS

FIG. 1 is a configuration example of a circuit device and an electronic apparatus including the circuit device.

FIG. 2 is a signal waveform example of the circuit device according to a first embodiment.

FIG. 3 is an example of a flowchart of first processing of determining voltage control data according to the first embodiment.

FIG. 4 is an example of a table.

FIG. 5 is an example of a flowchart of second processing of determining the voltage control data according to the first embodiment.

FIG. 6 is a detailed configuration example of a charging circuit and a backflow prevention circuit.

FIG. 7 is an example of a simulation result of characteristics of a charging current with respect to charging current control data.

FIG. 8 shows examples of a set voltage.

FIG. 9 is a detailed configuration example of a linear regulator circuit.

FIG. 10 shows examples of a power supply voltage for voltage control data.

FIG. 11 is a signal waveform example of a circuit device according to a second embodiment.

FIG. 12 is an example of a flowchart of processing of determining voltage control data according to the second embodiment.

FIG. 13 is a signal waveform example of a circuit device according to a third embodiment.

FIG. 14 is an example of a flowchart of processing of determining voltage control data according to the third embodiment.

FIG. 15 is a configuration example of a contactless power transmission system.

### DESCRIPTION OF EMBODIMENTS

Hereinafter, preferred embodiments of the present disclosure will be described in detail. The embodiments to be described below do not unduly limit contents described in the claims, and not all configurations described in the embodiments are necessarily essential components.

### 1. First Embodiment

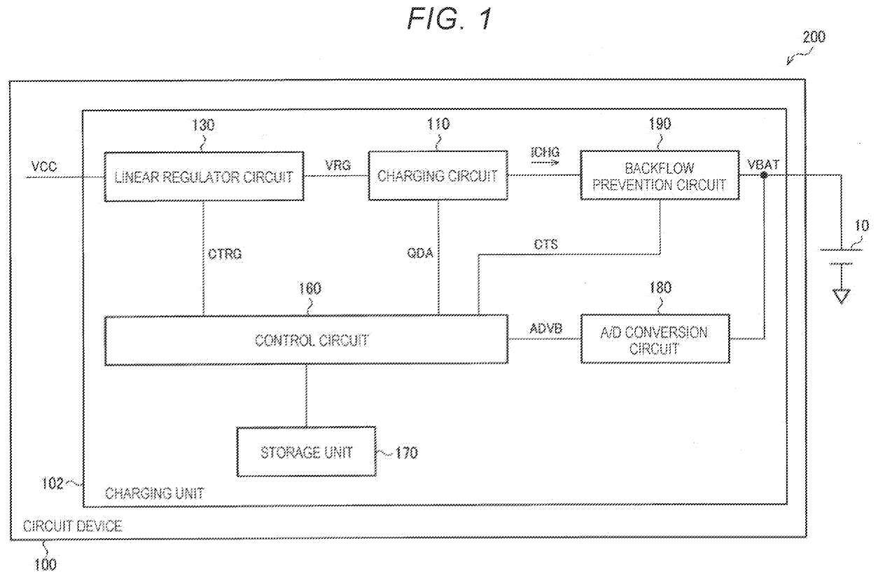

FIG. 1 is a configuration example of a circuit device and an electronic apparatus including the circuit device.

An electronic apparatus 200 includes a circuit device 100 and a battery 10. The battery 10 is a secondary battery, such as a lithium ion secondary battery, a nickel hydrogen storage battery, or a nickel cadmium storage battery. The electronic apparatus 200 may be any device that includes or can be attached to the battery 10, and may be various electronic apparatuses having a battery charging function. For example, the electronic apparatus 200 is a smart phone, a tablet terminal, a wireless earphone, a wireless hearing aid, a smart watch, a digital camera, or a mobile battery. When the electronic apparatus 200 is a smart phone or the like, the electronic apparatus 200 may include a processing device, a storage device, a wireless communication device, a display device, an operation input device, or the like. The electronic apparatus 200 may be an apparatus on a power reception side of a contactless power transmission system or an apparatus on a power reception side of a contact charging system.

The circuit device 100 includes a charging unit 102 that charges the battery 10 based on power transmitted from an apparatus on a power transmission side. The charging unit 102 includes a charging circuit 110, a linear regulator circuit 130, a control circuit 160, a storage unit 170, an A/D conversion circuit 180, and a backflow prevention circuit 190. The circuit device 100 is, for example, an integrated circuit device in which a plurality of circuit elements are integrated on a semiconductor substrate.

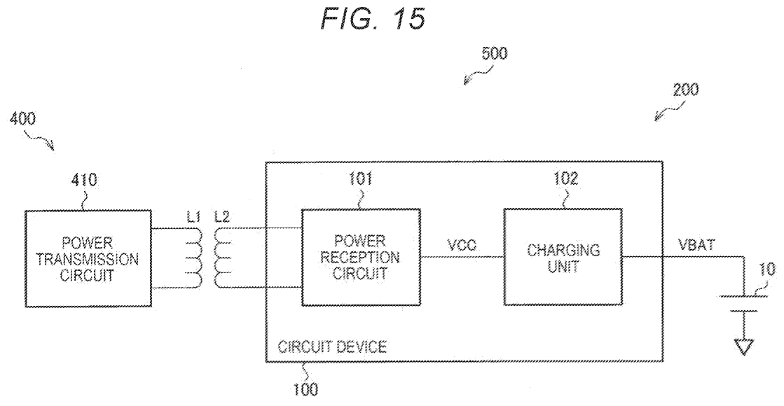

The linear regulator circuit 130 regulates an input voltage VCC to a power supply voltage VRG. The linear regulator circuit is a circuit that regulates a voltage using a voltage drop in a resistor, a transistor, or the like. A voltage value of the power supply voltage VRG is set by voltage control data CTRG from the control circuit 160. The input voltage VCC may be generated based on the power received from the apparatus on the power transmission side or may be a voltage received from the apparatus on the power transmission side. For example, in a contactless power transmission system to be described later with reference to FIG. 15, an AC voltage received by a power reception circuit 101 is rectified, and a DC voltage obtained therefrom is the input voltage VCC.

The charging circuit 110 generates a charging current ICHG for charging the battery 10 based on the power supply voltage VRG. A current value of the charging current ICHG is set by charging current control data QDA from the control circuit 160.

The backflow prevention circuit 190 is controlled to be on or off based on a control signal CTS from the control circuit 160. When the backflow prevention circuit 190 is turned on, the backflow prevention circuit 190 allows the charging current ICHG to flow from the charging circuit 110 to the battery 10. Accordingly, the battery 10 is charged with the charging current ICHG. When the backflow prevention circuit 190 is turned off and the charging circuit 110 does not output the charging current ICHG, the backflow prevention circuit 190 prevents a backflow from the battery 10 to the charging circuit 110.

The A/D conversion circuit 180 A/D-converts a battery voltage VBAT of the battery 10 and outputs battery voltage data ADVB as a result of the A/D conversion. The A/D conversion circuit 180 A/D-converts the battery voltage VBAT at predetermined intervals, for example, and outputs time-series battery voltage data ADVB.

The control circuit 160 outputs the voltage control data CTRG for controlling the voltage value of the power supply voltage VRG, the charging current control data QDA for controlling the current value of the charging current ICHG, and the control signal CTS for controlling the backflow prevention circuit 190 to be on or off. The control circuit 160 is a logic circuit including logic elements such as an AND circuit, an OR circuit, an inverter, and a latch circuit. The control circuit 160 may be a processor such as a DSP. The processor may implement a function of the control circuit 160 by executing a program that describes processing to be executed by the control circuit 160.

The control circuit 160 outputs the voltage control data CTRG based on the battery voltage data ADVB such that the power supply voltage VRG is a voltage obtained by adding a given set voltage to the battery voltage VBAT. The control circuit 160 may keep the given set voltage constant or variably control the given set voltage. For example, based on the charging current control data QDA, the control circuit 160 may change the given set voltage according to the current value of the charging current ICHG, or change the given set voltage between CC charging and CV charging. CC is an abbreviation of constant current, and CV is an abbreviation of constant voltage.

The control circuit 160 outputs the charging current control data QDA set according to the battery voltage VBAT. For example, the control circuit 160 determines a charging mode and the current value of the charging current ICHG by itself based on the battery voltage data ADVB, and outputs the charging current control data QDA. The charging mode is the CC charging or the CV charging. Alternatively, the control circuit 160 may transmit the battery voltage data ADVB to an external processing device via an interface circuit (not shown). The external processing device may determine the charging mode and the current value of the charging current ICHG based on the battery voltage data ADVB and transmit the charging current control data QDA to the interface circuit. The control circuit 160 may output the received charging current control data QDA to the charging circuit 110.

The storage unit 170 stores a set value of the given set voltage. The control circuit 160 reads the set value of the given set voltage from the storage unit 170, and outputs the voltage control data CTRG based on the set value. When the given set voltage is changed according to the charging current or the like, the storage unit 170 may store a plurality of given set voltages. When the control circuit 160 obtains the voltage control data CTRG from a table, the storage unit 170 may store data of the table. However, the table may be incorporated in the control circuit 160 as a circuit.

The storage unit 170 is a memory, a register, or the like. The memory is, for example, a nonvolatile memory or a RAM. The memory may be implemented by combining a nonvolatile memory and a register, or may be a fuse, a circuit outside the circuit device 100, or the like as long as it can store data. When the storage unit 170 is a nonvolatile memory, the set value of the given set voltage, or the like is written into the storage unit 170 at the time of manufacturing the circuit device 100 or the electronic apparatus 200, for example. When the storage unit 170 is a RAM or a register, the set value of the given set voltage, or the like is written into the storage unit 170 from the processing device outside the circuit device 100 via an interface circuit (not shown), for example.

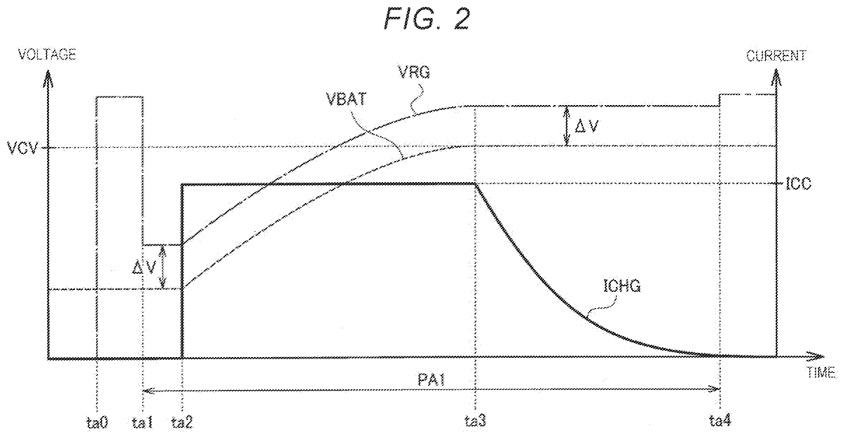

FIG. 2 is a signal waveform example of a circuit device according to a first embodiment. At time ta0, the electronic apparatus 200 is installed on a charging stand, which is an apparatus on the power transmission side, and power transmission from the charging stand to the electronic apparatus 200 is started.

The A/D conversion circuit 180 A/D-converts the battery voltage VBAT and outputs the battery voltage data ADVB. The control circuit 160 determines the voltage control data CTRG such that VRG=VBAT+ΔV based on the set value of the given set voltage ΔV read from the storage unit 170 and the battery voltage data ADVB. At time ta1, the control circuit 160 outputs the voltage control data CTRG to the linear regulator circuit 130, and the linear regulator circuit 130 outputs the power supply voltage VRG having a voltage value set by the voltage control data CTRG.

At time ta2, the charging circuit 110 starts the CC charging. In the CC charging, the charging circuit 110 charges the battery 10 with the charging current ICHG having a current value ICC set by the charging current control data QDA.

The control circuit 160 or the external processing device determines whether the battery voltage VBAT reaches a predetermined voltage VCV based on the battery voltage data ADVB, and switches from the CC charging to the CV charging when the battery voltage VBAT reaches the predetermined voltage. In FIG. 2, the CC charging is switched to the CV charging at time ta3.

The control circuit 160 or the external processing device controls the charging current control data QDA based on the battery voltage data ADVB such that the battery voltage VBAT is maintained at the constant voltage VCV. Accordingly, the current value of the charging current ICHG decreases. Based on the charging current control data QDA, the control circuit 160 or the external processing device stops the charging when the current value of the charging current ICHG is a predetermined value or less. In FIG. 2, the charging is stopped at time ta4.

Under the above control, a difference between the power supply voltage VRG output from the linear regulator circuit 130 and the battery voltage VBAT is maintained at a given set voltage ΔV during a period PA1 from the time ta1 to the time ta4. Since heat generation in the charging circuit 110 and the backflow prevention circuit 190 is determined by (VRG−VBAT)×ICHG=ΔV×ICHG, the heat generation is limited in the embodiment as compared with a case where the power supply voltage VRG is constant. Since the current value of the charging current ICHG and the given set voltage ΔV are independently set under digital control, appropriate charging control can be performed.

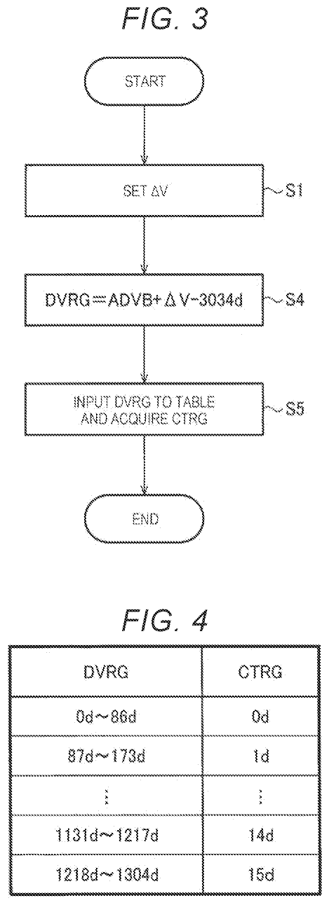

FIG. 3 is an example of a flowchart of first processing of determining the voltage control data according to the first embodiment. In step S1, the control circuit 160 reads a set value from the storage unit 170 and sets the given set voltage ΔV. Here, ΔV is a digital value obtained by converting a voltage value into an output code of the A/D conversion circuit 180.

In step S4, the control circuit 160 calculates a digital value DVRG=ADVB+ΔV−3034d. The “d” in 3034d indicates that 3034 is a decimal number. The 3034d is a value obtained by converting 3.5 V into the output code of the A/D conversion circuit 180, and corresponds to a lower limit of the power supply voltage VRG.

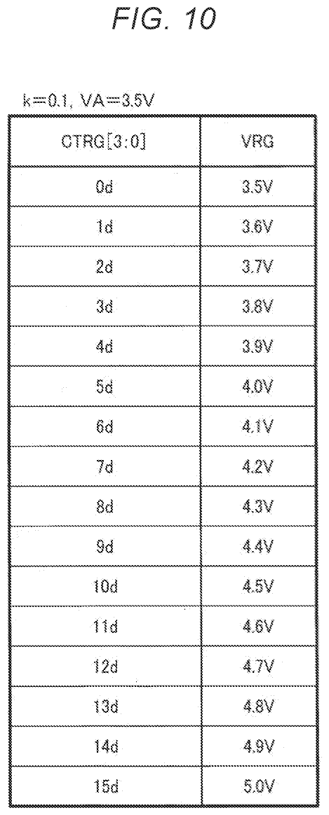

In step S5, the control circuit 160 inputs the digital value DVRG to the table and acquires the voltage control data CTRG corresponding to the digital value DVRG. FIG. 4 shows an example of the table. This table may be stored in the storage unit 170 or incorporated in the control circuit 160 as a circuit. FIG. 4 shows the example in which the linear regulator circuit 130 can output 3.5 V to 5.0 V in steps of 0.1 V. The table associates the digital value DVRG with the voltage control data CTRG of 0d to 15d in steps of 87d. The 87d is a value obtained by converting 0.1 V into the output code of the A/D conversion circuit 180. As will be described later with reference to FIG. 10, the linear regulator circuit 130 outputs power supply voltages VRG=3.5 V, 3.6 V, . . . , 4.9 V, and 5.0 V when CTRG=0d, 1d, . . . , 14d, and 15d.

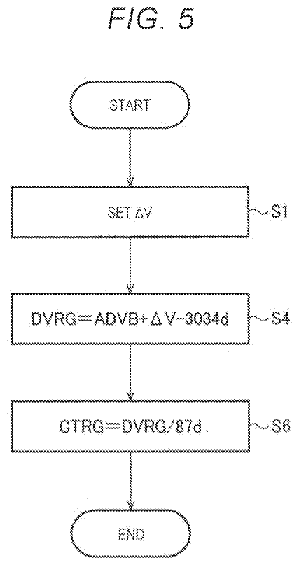

FIG. 5 is an example of a flowchart of second processing of determining the voltage control data according to the first embodiment. The same steps as those described above are denoted by the same reference signs, and the description thereof is omitted as appropriate.

In step S6, the control circuit 160 acquires the voltage control data CTRG by calculating CTRG=DVRG/87d and rounding off a remainder of the division. The control circuit 160 may execute steps S4 and S6 in one step by calculating CTRG=(ADVB+ΔV−3034d)/87d.

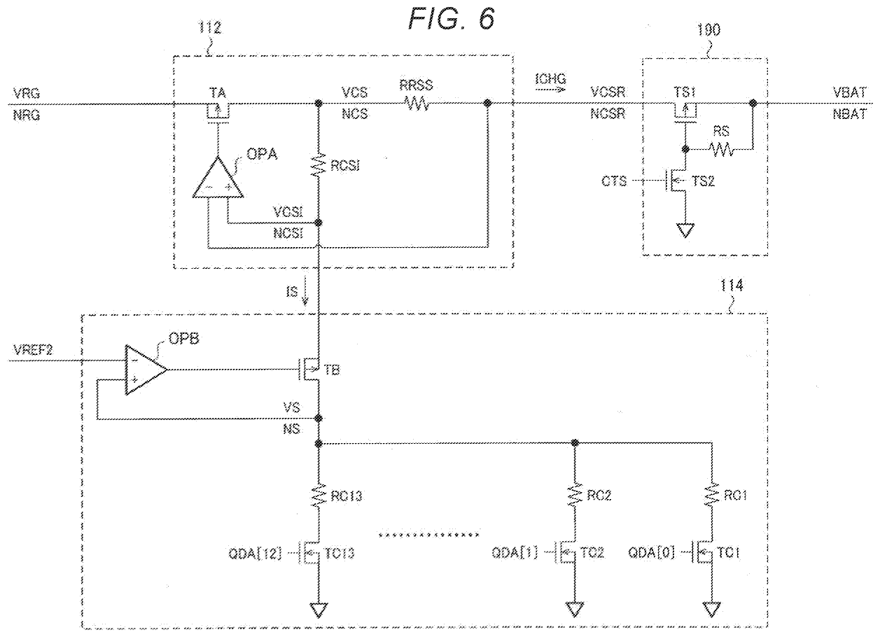

FIG. 6 is a detailed configuration example of the charging circuit and the backflow prevention circuit. First, a detailed configuration example of the backflow prevention circuit 190 will be described.

The backflow prevention circuit 190 includes a P-type transistor TS1, an N-type transistor TS2, and a resistor RS. A source of the P-type transistor TS1 is coupled to a charging node NBAT, and a drain thereof is coupled to an output node NCSR of the charging circuit 110. A source of the N-type transistor TS2 is coupled to a ground node, and a drain thereof is coupled to a gate of the P-type transistor TS1. The control signal CTS from the control circuit 160 is input to a gate of the N-type transistor TS2. One end of the resistor RS is coupled to the charging node NBAT, and the other end thereof is coupled to the gate of the P-type transistor TS1. When the control circuit 160 turns off the N-type transistor TS2, the P-type transistor TS1 is turned off. Since the P-type transistor TS1 includes a parasitic diode whose forward direction is a direction from the output node NCSR to the charging node NBAT, the backflow prevention circuit 190 prevents backflow from the battery 10 to the charging circuit 110 when the P-type transistor TS1 is turned off. When the battery 10 is being charged, the control circuit 160 turns on the N-type transistor TS2. Accordingly, the P-type transistor TS1 is turned on.

Next, a detailed configuration example of the charging circuit 110 will be described. The charging circuit 110 includes a current amplifier circuit 112 and a current source circuit 114 shown in FIG. 6.

The current source circuit 114 includes an operational amplifier OPB, a P-type transistor TB, resistors RC1 to RC13, and N-type transistors TC1 to TC13. An example in which the charging current control data QDA is 13 bits is shown here, but the number of bits of the charging current control data QDA may be two or more.

A source of the P-type transistor TB is coupled to a node NCSI, and a drain thereof is coupled to a node NS. A reference voltage VREF2 is input to an inverting input terminal of the operational amplifier OPB. A non-inverting input terminal of the operational amplifier OPB is coupled to the node NS, and an output node thereof is coupled to a gate of the P-type transistor TB. One end of the resistor RC1 is coupled to the node NS, and the other end thereof is coupled to a drain of the N-type transistor TC1. A source of the N-type transistor TC1 is coupled to a ground node. Similarly, one ends of the resistors RC2 to RC13 are coupled to the node NS, and the other ends thereof are coupled to drains of the N-type transistors TC2 to TC13. Sources of the N-type transistors TC2 to TC13 are coupled to ground nodes. A bit signal QDA[0] of the charging current control data QDA is input to a gate of the N-type transistor TC1. Similarly, bit signals QDA[1] to QDA[12] of the charging current control data QDA are input to gates of the N-type transistors TC2 to TC13.

The operational amplifier OPB and the P-type transistor TB control a voltage of the node NS to be VS=VREF2. The resistor RC1 and the N-type transistor TC1 are referred to as a first current source of the current source circuit 114. When the bit signal QDA[0] of the charging current control data QDA is 1, the N-type transistor TC1 is turned on, and the first current source causes a current of VREF2/RC1 to flow. Similarly, the resistors RC2 to RC13 and the N-type transistors TC2 to TC13 are referred to as second to thirteenth current sources of the current source circuit 114. When the bit signals QDA[1] to QDA[12] of the charging current control data QDA are 1, the N-type transistors TC2 to TC13 are turned on, and the second to thirteenth current sources cause currents of VREF2/RC2 to VREF2/RC13 to flow. When i is an integer of 1 or more and 13 or less, a resistance value of a resistor RCi is RCX/2⁽ⁱ⁻¹⁾. Here, RCX is any resistance value. That is, the currents flowing from the first to thirteenth current sources are weighted in binary. An output current IS flowing through the P-type transistor TB is a sum of currents flowing from current sources corresponding to bit signals QDA[0] to QDA[12] of the charging current control data QDA, which are 1.

The current amplifier circuit 112 includes an operational amplifier OPA, a current control transistor TA, a resistor RCSI, and a sense resistor RRSS.

The current control transistor TA is a P-type transistor. A source of the current control transistor TA is coupled to an output node NRG of the linear regulator circuit 130, and a drain thereof is coupled to a node NCS. One end of the resistor RCSI is coupled to the node NCS, and the other end thereof is coupled to the node NCSI. One end of the sense resistor RRSS is coupled to the node NCS, and the other end thereof is coupled to the output node NCSR of the charging circuit 110. A non-inverting input terminal of the operational amplifier OPA is coupled to the node NCSI, an inverting input terminal thereof is coupled to the output node NCSR of the charging circuit 110, and an output node thereof is coupled to a gate of the current control transistor TA.

The current amplifier circuit 112 generates the charging current ICHG by amplifying the output current IS with a gain RCSI/RRSS. That is, the current amplifier circuit 112 supplies the charging current ICHG=(RCSI/RRSS)×IS to the output node NCSR. The charging current ICHG is supplied to the charging node NBAT via the backflow prevention circuit 190 to charge the battery 10.

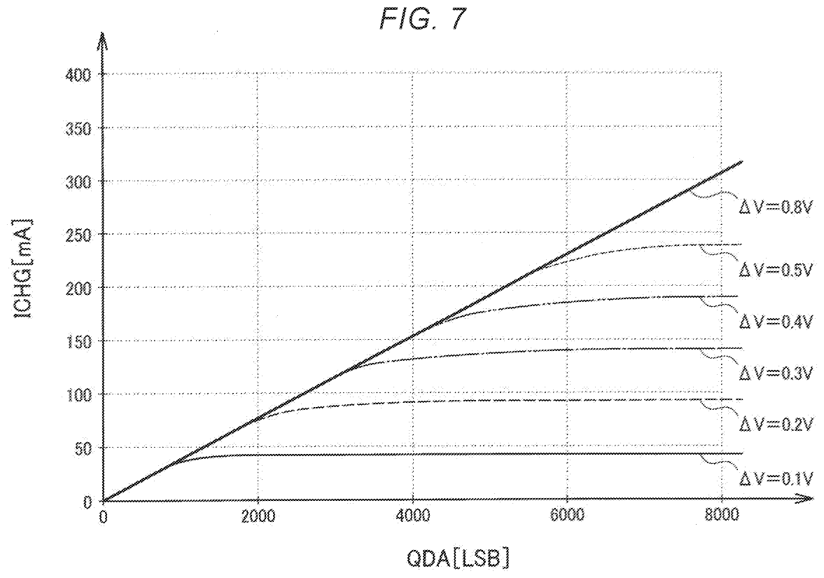

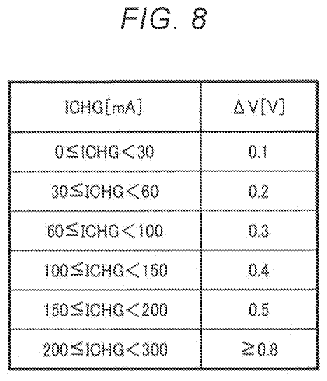

FIG. 7 is an example of a simulation result of characteristics of the charging current with respect to the charging current control data. FIG. 7 shows the simulation result in a worst case where an upper limit of ICHG when QDA is increased is lower than that in a typical case.

As shown in FIG. 7, the lower the set voltage ΔV is, the lower the upper limit of the charging current ICHG is. Within a range of the charging current ICHG lower than the upper limit, the charging current ICHG is linear with respect to the charging current control data QDA. For example, when ΔV=0.5 V, the upper limit of the charging current ICHG is approximately 240 mA, and the charging current ICHG is linear with respect to the charging current control data QDA within a range of approximately 0 mA to 200 mA.

From a viewpoint of minimizing the heat generation in the charging circuit 110 and the backflow prevention circuit 190, it is desirable that the set voltage ΔV is as low as possible within a range where the charging current ICHG is linear with respect to the charging current control data QDA. For example, when ICHG≤200 mA, the charging current ICHG is linear with respect to the charging current control data QDA if the set voltage is ΔV≥0.5 V. In this case, it is desirable to set ΔV≥0.5 V.

Here, in FIG. 6, ΔV=VRG−VBAT=ICHG×RRSS+VDS, in which a drain-source voltage of the current control transistor TA is VDS and a voltage drop of the backflow prevention circuit 190 can be ignored. For example, when RRSS=1 Ω and ICHG=200 mA, ΔV=0.2 V+VDS≥0.5 V. When a minimum value of VDS is VDSmin, VDSmin=0.3 V and ΔV≥0.2 V+VDSmin. VDSmin means a minimum drain-source voltage required for the charging current ICHG to be linear with respect to the charging current control data QDA. That is, by setting the set voltage to ΔV≥ICHG×RRSS+VDSmin, the charging current ICHG can be made linear with respect to the charging current control data QDA. By reducing the set voltage ΔV as much as possible within a range satisfying ΔV≥ICHG×RRSS+VDSmin, the heat generation in the charging circuit 110 and the backflow prevention circuit 190 can be minimized.

FIG. 8 shows examples of the set voltage. By setting the set voltage ΔV as shown in FIG. 8, it is possible to satisfy a condition that the charging current ICHG is linear with respect to the charging current control data QDA in FIG. 7 and the set voltage ΔV is as low as possible.

In the first embodiment, since the set voltage ΔV is constant, for example, when charging is performed within a range of 0 mA≤ICHG<200 mA, the constant ΔV=0.5 V is set regardless of the current value of the charging current ICHG.

Alternatively, as will be described later in a second embodiment, the set voltage ΔV may be changed according to the current value of the charging current ICHG. For example, when the charging current is set to ICHG=20 mA, the set voltage may be set to ΔV=0.1 V because 0 mA≤ICHG<30 mA, and when the charging current is set to 40 mA, the set voltage may be set to ΔV=0.2 V because 30 mA≤ICHG<60 mA.

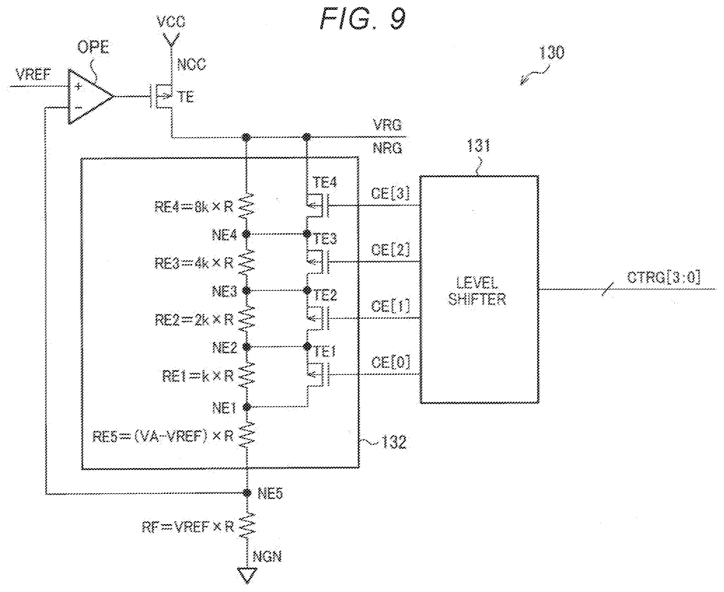

FIG. 9 is a detailed configuration example of the linear regulator circuit. The linear regulator circuit 130 includes an operational amplifier OPE, a transistor TE, a variable resistor circuit 132, a resistor RF, and a level shifter 131.

A reference voltage VREF is input to a non-inverting input terminal of the operational amplifier OPE. An inverting input terminal of the operational amplifier OPE is coupled to a node NE5, and an output terminal thereof is coupled to a gate of the transistor TE. The transistor TE is a P-type transistor. A source of the transistor TE is coupled to an input node NCC of the input voltage VCC, and a drain thereof is coupled to the output node NRG of the power supply voltage VRG. One end of the variable resistance circuit 132 is coupled to the output node NRG of the power supply voltage VRG, and the other end thereof is coupled to the node NE5. One end of the resistor RF is coupled to the node NE5, and the other end thereof is coupled to a ground node NGN.

A resistance value of the variable resistance circuit 132 is variably set based on the voltage control data CTRG from the control circuit 160. Specifically, using n, which is an integer of 1 or more, the variable resistance circuit 132 includes first to (n+1)-th resistors RE1 to REn+1 and first to n-th transistors TE1 to TEn. In FIG. 4, n=4. Hereinafter, n=4, but n may be any integer of 1 or more.

One end of a fourth resistor RE4 is coupled to the output node NRG of the power supply voltage VRG, and the other end thereof is coupled to a node NE4. One end of a third resistor RE3 is coupled to the node NE4, and the other end thereof is coupled to a node NE3. One end of a second resistor RE2 is coupled to the node NE3, and the other end thereof is coupled to a node NE2. One end of a first resistor RE1 is coupled to the node NE2, and the other end is coupled to a node NE1. One end of a fifth resistor RE5 is coupled to the node NE1, and the other end thereof is coupled to the node NE5.

The first to fourth transistors TE1 to TE4 are P-type transistors. A source of the fourth transistor TE4 is coupled to the output node NRG of the power supply voltage VRG, and a drain thereof is coupled to the node NE4. A source of the third transistor TE3 is coupled to the node NE4, and a drain thereof is coupled to the node NE3. A source of the second transistor TE2 is coupled to the node NE3, and a drain thereof is coupled to the node NE2. A source of the first transistor TE1 is coupled to the node NE2, and a drain thereof is coupled to the node NE1.

The level shifter 131 level-shifts a bit signal CTRG[0] of the voltage control data CTRG from a signal level of a power supply voltage of the control circuit 160 to a signal level of the power supply voltage VRG, and outputs a signal CE[0] to a gate of the first transistor TE1. Similarly, the level shifter 131 level-shifts bit signals CTRG[1] to CTRG[3] of the voltage control data CTRG, and outputs signals CE[1] to CE[3] to gates of the second to fourth transistors TE2 to TE4.

Logic levels of signals CE[0] to CE[3] are the same as logic levels of bit signals CTRG[0] to CTRG[3]. When CTRG[0]=0, the first transistor TE1 is turned on, and both ends of the first resistor RE1 are short-circuited. When CTRG[0]=1, the first transistor TE1 is turned off, and both ends of the first resistor RE1 are not short-circuited. Similarly, when CTRG[1] to CTRG[3] are 0, the second to fourth transistors TE2 to TE4 are turned on, and both ends of each of the second to fourth resistors RE2 to RE4 are short-circuited. When CTRG[1] to CTRG[3] are 1, the second to fourth transistors TE2 to TE4 are turned off, and both ends of each of the second to fourth resistors RE2 to RE4 are not short-circuited.

From the above, the power supply voltage VRG is expressed by the following equation (1). In addition, j is an integer of 1 or more and n or less, and here n=4.

$$\begin{matrix}[ Equation 1 ] & \\ VRG = ( 1 + \frac{( {\sum }_{j = 1}^{4} REj \times CTRG [ j - 1 ] ) + RE 5}{RF} ) \times VREF & ( 1 )\end{matrix}$$

As shown in FIG. 9, a resistance value of a j-th resistor REj is set to 2^{(j-1)}×k×R, a resistance value of the fifth resistor RE5 is set to (VA−VREF)×R, a resistance value of the resistor RF is set to VREF×R. In addition, k is a voltage step of the power supply voltage VRG. VA is the lower limit of the power supply voltage VRG. R is any real number greater than 0. When these resistance values are substituted into the above equation (1), the power supply voltage VRG is expressed by the following equation (2). That is, the linear regulator circuit 130 outputs the power supply voltage VRG of the voltage step k with the voltage VA as the lower limit. The following equation (2) does not depend on the reference voltage VREF and any real number R.

$$\begin{matrix}[ Equation 2 ] & \\ VRG = k \times ( {\sum }_{j = 1}^{4} {2}^{j - 1} \times CTRG [ j - 1 ] ) + V A & ( 1 )\end{matrix}$$

FIG. 10 shows examples of the power supply voltage for the voltage control data. Here, k=0.1 V and VA=3.5 V. In this example, the linear regulator circuit 130 outputs power supply voltages VRG=3.5 V, 3.6 V, . . . , 4.9 V, and 5.0 V in 16 gradations in steps of 0.1 V for CTRG[3:0]=0d, 1d, . . . , 14d, and 15d.

In the above embodiment, the circuit device 100 includes the charging circuit 110, the A/D conversion circuit 180, the control circuit 160, and the linear regulator circuit 130. The charging circuit 110 supplies the charging current ICHG to the battery 10 based on the power supply voltage VRG. The A/D conversion circuit 180 A/D-converts the battery voltage VBAT, which is a voltage of the battery 10, and outputs the battery voltage data ADVB. The control circuit 160 outputs the voltage control data CTRG for controlling the voltage value of the power supply voltage VRG based on the battery voltage data ADVB such that the difference between the power supply voltage VRG and the battery voltage VBAT is the given set voltage ΔV. The linear regulator circuit 130 supplies the power supply voltage VRG to the charging circuit 110 based on the voltage control data CTRG.

According to the embodiment, the difference between the power supply voltage VRG output from the linear regulator circuit 130 and the battery voltage VBAT is maintained at the given set voltage ΔV during a period in which the battery 10 is being charged. Heat generation in a circuit provided between an output of the linear regulator circuit 130 and the battery 10 is determined by (given set voltage ΔV)×(charging current ICHG), and thus the heat generation is limited in the embodiment as compared with the case where the power supply voltage VRG is constant.

In the embodiment, the control circuit 160 outputs the charging current control data QDA for controlling the charging current ICHG. The charging circuit 110 supplies the battery 10 with the charging current ICHG controlled based on the charging current control data QDA.

According to the embodiment, the current value of the charging current ICHG and the given set voltage ΔV can be independently set under the digital control. Accordingly, an appropriate current value of the charging current ICHG and an appropriate given set voltage ΔV can be set according to a charging state. For example, as will be described later in the second embodiment, the given set voltage ΔV can be appropriately controlled according to the current value of the charging current ICHG. Alternatively, as will be described later in a third embodiment, the current value of the charging current ICHG and the given set voltage ΔV can be appropriately controlled according to the CC charging or the CV charging.

In the embodiment, the charging circuit 110 includes the current control transistor TA, the sense resistor RRSS, and an amplifier circuit. The current control transistor TA and the sense resistor RRSS are provided in series between the output node NRG of the power supply voltage VRG and the output node NCSR of the charging current ICHG. The amplifier circuit controls the current control transistor TA based on a potential difference of the sense resistor RRSS. In the configuration example in FIG. 6, the operational amplifier OPA and the resistor RCSI correspond to the amplifier circuit.

According to the embodiment, the current control transistor TA and the sense resistor RRSS generate heat when the charging current ICHG flows through the current control transistor TA and the sense resistor RRSS. An amount of heat generated at this time is determined by the difference between the power supply voltage VRG and the battery voltage VBAT, and the charging current ICHG. According to the embodiment, since the difference between the power supply voltage VRG and the battery voltage VBAT is maintained at the given set voltage ΔV, the heat generation is reduced as compared with the case where the power supply voltage VRG is constant.

In the embodiment, ΔV≥ICHG×RRSS+VDSmin, in which the charging current is ICHG, a resistance value of the sense resistor is RRSS, a minimum drain-source voltage of the current control transistor TA for causing the charging current to flow is VDSmin, and the given set voltage is ΔV. A meaning of VDSmin, which is the minimum drain-source voltage, is as described with reference to FIG. 7.

According to the embodiment, by setting the given set voltage to ΔV≥ICHG×RRSS+VDSmin, the difference between the power supply voltage VRG and the battery voltage VBAT can be maintained at the given set voltage ΔV while keeping the charging current ICHG linear with respect to the charging current control data QDA. By reducing the given set voltage ΔV to a voltage as much as possible within the range satisfying ΔV≥ICHG×RRSS+VDSmin, the heat generation can be minimized while keeping the charging current ICHG linear with respect to the charging current control data QDA.

In the embodiment, the linear regulator circuit 130 includes the operational amplifier OPE, the transistor TE, the variable resistance circuit 132, and the resistor RF. The reference voltage VREF is input to the non-inverting input terminal of the operational amplifier OPE. The transistor TE is provided between the input node NCC of the input voltage VCC and the output node NRG of the power supply voltage VRG. An output voltage of the operational amplifier OPE is input to the gate of the transistor TE. The variable resistance circuit 132 is provided between the output node NRG of the power supply voltage VRG and the inverting input terminal of the operational amplifier OPE. The resistance value of the variable resistance circuit 132 is variably set based on the voltage control data CTRG. The resistor RF is provided between the inverting input terminal of the operational amplifier OPE and the ground node NGN.

According to the embodiment, the input voltage VCC is regulated to the power supply voltage VRG with a gain determined by a resistance ratio of the variable resistance circuit 132 to the resistor RF. By variably setting the resistance value of the variable resistance circuit 132 based on the voltage control data CTRG, the gain is variably set and the power supply voltage VRG is variably set.

In the embodiment, the variable resistance circuit 132 includes first to n-th resistors RE1 to REn, first to n-th transistors TE1 to TEn, and an (n+1)-th resistor REn+1. In addition, n is an integer of 1 or more. A j-th transistor TEj is provided in parallel with the j-th resistor REj, and is controlled to be on or off by the voltage control data CTRG. In addition, j is an integer of 1 or more and n or less. A step of the power supply voltage VRG corresponding to an LSB of the voltage control data CTRG is k, the lower limit of the power supply voltage VRG is VA, and R is any real number greater than 0. At this time, a resistance value of the j-th resistor REj is k×2^{(j-1)}×R. A resistance value of the (n+1)-th resistor REn+1 is (VA−VREF)×R. A resistance value of the resistor RF is VREF×R.

According to the embodiment, as described in the above equation (2), the power supply voltage VRG is expressed by the equation that does not depend on the reference voltage VREF and any real number R. That is, it is possible to implement the linear regulator circuit 130 that generates the power supply voltage VRG of the step k at the lower limit voltage VA using any reference voltage VREF and real number R.

### 2. Second Embodiment

Configuration examples and basic operations of the circuit device 100 and the electronic apparatus 200 according to a second embodiment are the same as those according to the first embodiment. Hereinafter, differences from the first embodiment will be mainly described.

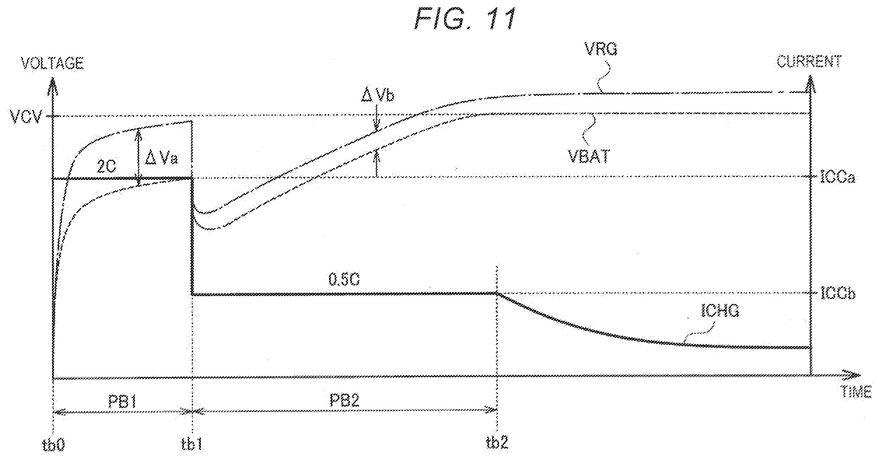

FIG. 11 is a signal waveform example of a circuit device according to the second embodiment. At time tb0, the charging circuit 110 starts first CC charging. In the first CC charging, the charging circuit 110 charges the battery 10 with the charging current ICHG having a first current value ICCa set by the charging current control data QDA. The control circuit 160 sets a set voltage to ΔV=ΔVa in the first CC charging, and determines the voltage control data CTRG such that VRG=VBAT+ΔVa.

The control circuit 160 or an external processing device determines whether the battery voltage VBAT reaches a predetermined voltage indicating switching to second CC charging based on the battery voltage data ADVB, and switches to the second CC charging when the battery voltage VBAT reaches the predetermined voltage. In FIG. 11, the first CC charging is switched to the second CC charging at time tb1.

In the second CC charging, the charging circuit 110 charges the battery 10 with the charging current ICHG having a second current value ICCb set by the charging current control data QDA. ICCb<ICCa, and ICCb=ICCa/4 in the example in FIG. 11. The control circuit 160 sets a set voltage to ΔV=ΔVb in the second CC charging, and determines the voltage control data CTRG such that VRG=VBAT+ΔVb. ΔVb<ΔVa. The set voltages ΔVa and ΔVb are determined in advance by a method described with reference to FIGS. 7 and 8, for example. When the battery voltage VBAT reaches the voltage VCV at time tb2, the second CC charging is switched to the CV charging.

Here, an example in which the set voltage ΔV is switched in two stages is shown, but the set voltage ΔV may be switched in three or more stages. For example, in third CC charging, the charging circuit 110 may charge the battery 10 with the charging current ICHG having a third current value smaller than the second current value ICCb. The control circuit 160 may set the set voltage to a voltage lower than ΔVb in the third CC charging.

The control circuit 160 or the external processing device determines whether the battery voltage VBAT reaches the voltage VCV indicating switching to the CV charging based on the battery voltage data ADVB, and switches from the second CC charging to the CV charging when the battery voltage VBAT reaches the voltage CVC. In FIG. 11, the second CC charging is switched to the CV charging at the time tb2.

Under the above control, a difference between the power supply voltage VRG and the battery voltage VBAT is maintained at the set voltage ΔVa during a period PB1 in which the battery 10 is charged with the charging current ICHG having the first current value ICCa. A difference between the power supply voltage VRG and the battery voltage VBAT is maintained at the set voltage ΔVb smaller than ΔVa during a period PB2 in which the battery 10 is charged with the charging current ICHG having the second current value ICCb smaller than the first current value ICCa. Since the difference between the power supply voltage VRG and the battery voltage VBAT is controlled to be smaller as a current value of the charging current ICHG is smaller, the set voltage ΔV can be reduced as much as possible within a range in which the charging current ICHG is linear with respect to the charging current control data QDA as described with reference to FIG. 7. Accordingly, heat generation is further limited as compared with that according to the first embodiment.

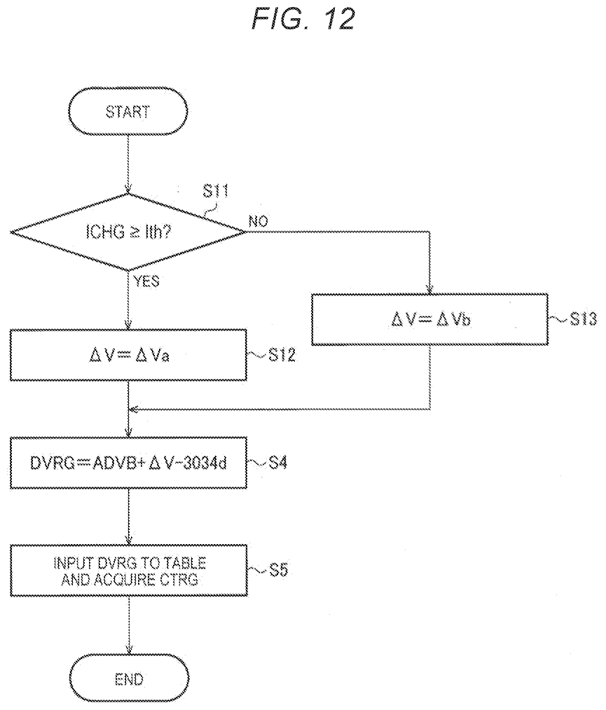

FIG. 12 is an example of a flowchart of processing of determining the voltage control data according to the second embodiment. The same steps as those described above are denoted by the same reference signs, and the description thereof is omitted as appropriate.

In step S11, the control circuit 160 determines whether a charging current is equal to or greater than a threshold Ith based on the charging current control data QDA. The control circuit 160 sets a set voltage to ΔV=ΔVa when the charging current is equal to or greater than the threshold Ith, and sets the set voltage to ΔV=ΔVb when the charging current is smaller than the threshold Ith. In the example in FIG. 11, ICCa<Ith<ICCb. Subsequent steps S4 and S5 are the same as those in FIG. 3. However, step S6 in FIG. 5 may be executed instead of step S5.

In the above embodiment, the control circuit 160 outputs the voltage control data CTRG corresponding to the charging current control data QDA.

According to the embodiment, the power supply voltage VRG can be controlled according to not only a voltage value of the battery voltage VBAT but also the current value of the charging current ICHG. For example, the power supply voltage VRG can be increased or reduced according to the current value of the charging current ICHG. Accordingly, an appropriate power supply voltage VRG corresponding to the current value of the charging current ICHG can be supplied from the linear regulator circuit 130 to the charging current ICHG.

Specifically, the control circuit 160 outputs the voltage control data CTRG such that the difference between the power supply voltage VRG and the battery voltage VBAT is the given set voltage ΔV corresponding to the charging current control data QDA.

According to the embodiment, the control circuit 160 can change the set voltage ΔV according to the charging current control data QDA. Accordingly, the difference between the power supply voltage VRG and the battery voltage VBAT can be set to an appropriate potential difference corresponding to the current value of the charging current ICHG.

More specifically, when the charging circuit 110 charges the battery 10 with the charging current ICHG having the first current value ICC1, the control circuit 160 outputs the voltage control data CTRG using a first set voltage as the given set voltage ΔV. When the charging circuit 110 charges the battery 10 with the charging current ICHG having the second current value ICC2 smaller than the first current value ICC1, the control circuit 160 outputs the voltage control data CTRG using a second set voltage lower than the first set voltage as the given set voltage ΔV. In the example in FIG. 11, ΔVa is the first set voltage, and ΔVb is the second set voltage.

According to the embodiment, by lowering the set voltage ΔV as the current value of the charging current ICHG decreases, the set voltage ΔV can be reduced as much as possible while keeping the charging current ICHG linear with respect to the charging current control data QDA. Accordingly, the heat generation can be further reduced as compared with a case where the set voltage ΔV is constant.

### 3. Third Embodiment

Configuration examples and basic operations of the circuit device 100 and the electronic apparatus 200 according to a third embodiment are the same as those according to the first embodiment. Hereinafter, differences from the first embodiment will be mainly described.

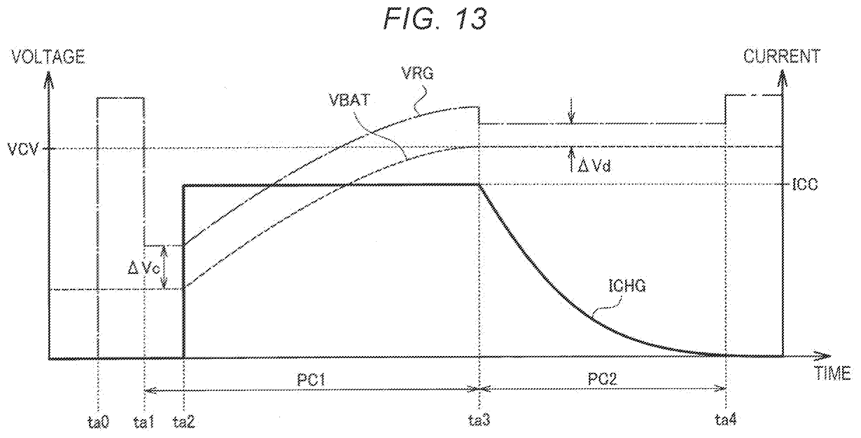

FIG. 13 is a signal waveform example of a circuit device according to the third embodiment. The control circuit 160 sets a set voltage to ΔV=ΔVc in the CC charging, and determines the voltage control data CTRG such that VRG=VBAT+ΔVc. The control circuit 160 sets a set voltage to ΔV=ΔVd in the CV charging, and determines the voltage control data CTRG such that VRG=VBAT+ΔVd. ΔVd<ΔVc.

Under the above control, a difference between the power supply voltage VRG and the battery voltage VBAT is maintained at the set voltage ΔVc during a period PC1 in which the battery 10 is charged by the CC charging. A difference between the power supply voltage VRG and the battery voltage VBAT is maintained at the set voltage ΔVd smaller than ΔVc during a period PC2 in which the battery 10 is charged by the CV charging. A charging current in the CV charging is smaller than a charging current in the CC charging. That is, since the difference between the power supply voltage VRG and the battery voltage VBAT is controlled to be smaller as a current value of the charging current ICHG is smaller, the set voltage ΔV can be reduced as much as possible within a range in which the charging current ICHG is linear with respect to the charging current control data QDA as described with reference to FIG. 7. Accordingly, heat generation is further limited as compared with that according to the first embodiment.

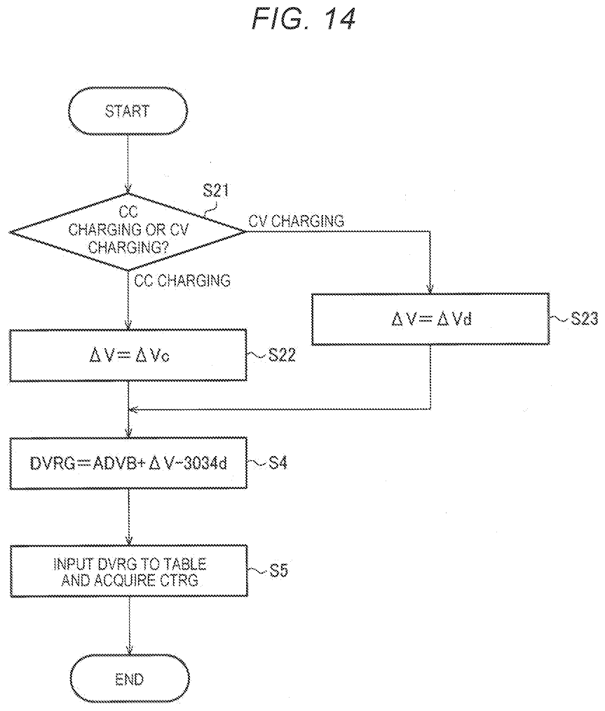

FIG. 14 is an example of a flowchart of processing of determining the voltage control data according to the third embodiment. The same steps as those described above are denoted by the same reference signs, and the description thereof is omitted as appropriate.

In step S21, the control circuit 160 determines whether a charging mode is the CC charging or the CV charging. The control circuit 160 sets the set voltage to ΔV=ΔVc when the charging mode is the CC charging, and sets the set voltage to ΔV=ΔVd when the charging mode is the CV charging. Subsequent steps S4 and S5 are the same as those in FIG. 3. However, step S6 in FIG. 5 may be executed instead of step S5.

In the above embodiment, when the charging circuit 110 performs the CC charging, the control circuit 160 outputs the voltage control data CTRG using a first set voltage as the given set voltage ΔV. When the charging circuit 110 performs the CV charging, the control circuit 160 outputs the voltage control data CTRG using a second set voltage lower than the first set voltage as the given set voltage ΔV. In the example in FIG. 13, ΔVc is the first set voltage, and ΔVd is the second set voltage.

According to the embodiment, the set voltage ΔV can be reduced in the CV charging in which the charging current is smaller than that in the CC charging. By lowering the set voltage ΔV as the current value of the charging current ICHG decreases, the set voltage ΔV can be reduced as much as possible while keeping the charging current ICHG linear with respect to the charging current control data QDA. Accordingly, the heat generation can be further reduced as compared with a case where the set voltage ΔV is constant.

### 4. Contactless Power Transmission System

As an example of a charging system including the electronic apparatus 200 according to the embodiment, an example of a charging system using contactless power transmission will be described.

FIG. 15 is a configuration example of the contactless power transmission system. A contactless power transmission system 500 includes an electronic apparatus 400 on a power transmission side and the electronic apparatus 200 on a power reception side. The electronic apparatus 400 on the power transmission side is, for example, a charging stand. When the electronic apparatus 200 on the power reception side is installed on the charging stand, the electronic apparatus 400 on the power transmission side transmits power to the electronic apparatus 200 on the power reception side.

The electronic apparatus 400 on the power transmission side includes a power transmission circuit 410 and a coil L1. The electronic apparatus 200 on the power reception side includes the circuit device 100 and a coil L2. The power transmission circuit 410 drives the coil L1 by an AC signal to transmit power from the coil L1 to the coil L2 on the power reception side. The circuit device 100 includes the power reception circuit 101 and the charging unit 102. In FIG. 1, the circuit device 100 is implemented by the charging unit 102, while in FIG. 15, the circuit device 100 further includes the power reception circuit 101. The circuit device 100 may not include the power reception circuit 101. The power reception circuit 101 generates a DC input voltage VCC by rectifying the AC signal received by the coil L2. The charging unit 102 charges the battery 10 based on the input voltage VCC. The charging unit 102 corresponds to the linear regulator circuit 130, the charging circuit 110, the backflow prevention circuit 190, the control circuit 160, the A/D conversion circuit 180, and the storage unit 170 in FIG. 1.

A circuit device according to the embodiment described above includes a charging circuit, an A/D conversion circuit, a control circuit, and a linear regulator circuit. The charging circuit supplies a charging current to a battery based on a power supply voltage. The A/D conversion circuit A/D-converts a battery voltage, which is a voltage of the battery, and outputs battery voltage data. The control circuit outputs voltage control data for controlling a voltage value of the power supply voltage based on the battery voltage data such that a difference between the power supply voltage and the battery voltage is a given set voltage. The linear regulator circuit supplies the power supply voltage to the charging circuit based on the voltage control data.

According to the embodiment, the difference between the power supply voltage output from the linear regulator circuit and the battery voltage is maintained at the given set voltage during a period in which the battery is being charged. Heat generation in a circuit provided between an output of the linear regulator circuit and the battery is determined by (the given set voltage)×(the charging current), and thus the heat generation is limited in the embodiment as compared with a case where the power supply voltage is constant.

In the embodiment, the control circuit may output charging current control data for controlling the charging current. The charging circuit may supply the battery with the charging current controlled based on the charging current control data.

According to the embodiment, a current value of the charging current and the given set voltage can be independently set under digital control. Accordingly, an appropriate current value of the charging current and an appropriate given set voltage can be set according to a charging state.

In the embodiment, the control circuit may output the voltage control data corresponding to the charging current control data.

According to the embodiment, the power supply voltage can be controlled according to not only the voltage value of the battery voltage but also the current value of the charging current. For example, the power supply voltage can be increased or reduced according to the current value of the charging current. Accordingly, an appropriate power supply voltage corresponding to the current value of the charging current can be supplied from the linear regulator circuit to the charging current.

In the embodiment, the control circuit may output the voltage control data such that the difference between the power supply voltage and the battery voltage is the given set voltage corresponding to the charging current control data.

According to the embodiment, the control circuit can change the set voltage according to the charging current control data. Accordingly, the difference between the power supply voltage and the battery voltage can be set to an appropriate potential difference corresponding to the current value of the charging current.

In the embodiment, when the charging circuit charges the battery with the charging current having a first current value, the control circuit may output the voltage control data using a first set voltage as the given set voltage. When the charging circuit charges the battery with the charging current having a second current value smaller than the first current value, the control circuit may output the voltage control data using a second set voltage lower than the first set voltage as the given set voltage.

According to the embodiment, by lowering the set voltage as the current value of the charging current decreases, the set voltage can be reduced as much as possible while keeping the charging current linear with respect to the charging current control data. Accordingly, the heat generation can be further reduced as compared with a case where the set voltage is constant.

In the embodiment, when the charging circuit performs CC charging, the control circuit may output the voltage control data using a first set voltage as the given set voltage. When the charging circuit performs CV charging, the control circuit may output the voltage control data using a second set voltage lower than the first set voltage as the given set voltage.

According to the embodiment, the set voltage can be reduced in the CV charging in which the charging current is smaller than that in the CC charging. By lowering the set voltage as the current value of the charging current decreases, the set voltage can be reduced as much as possible while keeping the charging current linear with respect to the charging current control data. Accordingly, the heat generation can be further reduced as compared with a case where the set voltage is constant.

In the embodiment, the charging circuit may include a current control transistor and a sense resistor that are provided in series between an output node of the power supply voltage and an output node of the charging current, and an amplifier circuit configured to control the current control transistor based on a potential difference of the sense resistor.

According to the embodiment, the current control transistor and the sense resistor generate heat when the charging current flows through the current control transistor and the sense resistor. An amount of heat generated at this time is determined by the difference between the power supply voltage and the battery voltage, and the charging current. According to the embodiment, since the difference between the power supply voltage and the battery voltage is maintained at the given set voltage, the heat generation is reduced as compared with the case where the power supply voltage is constant.

In the embodiment, ΔV≥ICHG×RRSS+VDSmin may be satisfied, in which the charging current is ICHG, a resistance value of the sense resistor is RRSS, a minimum drain-source voltage of the current control transistor for causing the charging current to flow is VDSmin, and the given set voltage is ΔV.

According to the embodiment, by setting the given set voltage to ΔV≥ICHG×RRSS+VDSmin, the difference between the power supply voltage and the battery voltage can be maintained at the given set voltage while keeping the charging current linear with respect to the charging current control data. By reducing the given set voltage to a voltage as much as possible within a range satisfying ΔV≥ICHG×RRSS+VDSmin, the heat generation can be minimized while keeping the charging current linear with respect to the charging current control data.

In the embodiment, the control circuit may obtain the voltage control data by arithmetic processing based on a set value of the given set voltage and the battery voltage data.

According to the embodiment, the voltage control data is calculated by digital processing based on the set value of the given set voltage and the battery voltage data. Accordingly, the voltage value of the power supply voltage is digitally controlled based on the battery voltage data such that the difference between the power supply voltage and the battery voltage is the given set voltage.

In the embodiment, the linear regulator circuit may include an operational amplifier, a transistor, a variable resistance circuit, and a resistor. A reference voltage may be input to a non-inverting input terminal of the operational amplifier. The transistor may be provided between an input node of an input voltage and an output node of the power supply voltage. An output voltage of the operational amplifier may be input to a gate of the transistor. The variable resistance circuit may be provided between the output node of the power supply voltage and an inverting input terminal of the operational amplifier. A resistance value of the variable resistance circuit may be variably set based on the voltage control data. The resistor may be provided between the inverting input terminal of the operational amplifier and a ground node.

According to the embodiment, the input voltage is regulated to the power supply voltage with a gain determined by a resistance ratio of the variable resistor circuit to the resistor. By variably setting the resistance value of the variable resistance circuit based on the voltage control data, the gain is variably set and the power supply voltage is variably set.

In the embodiment, the variable resistance circuit may include first to n-th resistors, first to n-th transistors, and an (n+1)-th resistor. In addition, n is an integer of 1 or more. A j-th transistor may be provided in parallel with a j-th resistor of the first to n-th resistors, and may be controlled to be on or off by the voltage control data. In addition, j is an integer of 1 or more and n or less. A step of the power supply voltage corresponding to an LSB of the voltage control data is k, a lower limit of the power supply voltage is VA, and R is any real number greater than 0. At this time, a resistance value of the j-th resistor may be k×2^{(j-1)}×R. A resistance value of the (n+1)-th resistor may be (VA−VREF)×R. A resistance value of the resistor may be VREF×R.

According to the embodiment, the power supply voltage is expressed by an equation that does not depend on the reference voltage VREF and any real number R. That is, it is possible to implement the linear regulator circuit that generates the power supply voltage of the step k at the lower limit voltage VA using any reference voltage VREF and real number R.

In the embodiment, the circuit device may include a power reception circuit that receives power transmitted by contactless power transmission. A voltage received by the power reception circuit may be input to the linear regulator circuit as the input voltage.

According to the embodiment, control on the power supply voltage output from the linear regulator circuit is completed in an apparatus on a power reception side in a contactless power transmission system. Accordingly, control on a power transmission side regarding control on the power supply voltage output from the linear regulator circuit is not required, and heat generation in a charging path from an output of the linear regulator circuit to the battery can be reduced without complicating a configuration of the contactless power transmission system.

An electronic apparatus according to the embodiment includes any one of the circuit devices described above and a battery.

In the embodiment, the control circuit 160 obtains the voltage control data CTRG by arithmetic processing based on the set value of the given set voltage ΔV and the battery voltage data ADVB.

According to the embodiment, the voltage control data CTRG is obtained by digital arithmetic processing based on the set value of the given set voltage ΔV and the battery voltage data ADVB.

Although the embodiment has been described in detail above, it will be easily understood by those skilled in the art that many modifications can be made without substantially departing from the novel matters and effects according to the present disclosure. Therefore, all such modifications are intended to be included within the scope of the present disclosure. For example, a term described at least once together with a different term having a broader meaning or the same meaning in the description or the drawings can be replaced with the different term in any place in the description or the drawings. All combinations of the embodiment and the modifications are also included in the scope of the present disclosure. Configurations, operations, and the like of the linear regulator circuit, the charging circuit, the control circuit, the A/D conversion circuit, the circuit device, the battery, the electronic apparatus, the contactless power transmission system, and the like are not limited to those described in the embodiment, and various modifications can be made.

What is claimed is:

1. A circuit device comprising:
a charging circuit configured to supply a charging current to a battery based on a power supply voltage;
an A/D conversion circuit configured to A/D-convert a battery voltage, which is a voltage of the battery, and to output battery voltage data;
a control circuit configured to output voltage control data for controlling a voltage value of the power supply voltage based on the battery voltage data such that a difference between the power supply voltage and the battery voltage is a given set voltage; and
a linear regulator circuit configured to supply the power supply voltage to the charging circuit based on the voltage control data.

2. The circuit device according to claim 1, wherein
the control circuit outputs charging current control data for controlling the charging current, and
the charging circuit supplies the battery with the charging current controlled based on the charging current control data.

3. The circuit device according to claim 2, wherein
the control circuit outputs the voltage control data corresponding to the charging current control data.

4. The circuit device according to claim 2, wherein
the control circuit outputs the voltage control data such that the difference between the power supply voltage and the battery voltage is the given set voltage corresponding to the charging current control data.

5. The circuit device according to claim 4, wherein
the control circuit
when the charging circuit charges the battery with the charging current having a first current value, outputs the voltage control data using a first set voltage as the given set voltage, and
when the charging circuit charges the battery with the charging current having a second current value smaller than the first current value, outputs the voltage control data using a second set voltage lower than the first set voltage as the given set voltage.

6. The circuit device according to claim 1, wherein
the control circuit
when the charging circuit performs constant current (CC) charging, outputs the voltage control data using a first set voltage as the given set voltage, and
when the charging circuit performs constant voltage (CV) charging, outputs the voltage control data using a second set voltage lower than the first set voltage as the given set voltage.

7. The circuit device according to claim 1, wherein
the charging circuit includes
a current control transistor and a sense resistor that are provided in series between an output node of the power supply voltage and an output node of the charging current, and
an amplifier circuit configured to control the current control transistor based on a potential difference of the sense resistor.

8. The circuit device according to claim 7, wherein
ΔV≥ICHG×RRSS+VDSmin, in which the charging current is ICHG, a resistance value of the sense resistor is RRSS, a minimum drain-source voltage of the current control transistor for causing the charging current to flow is VDSmin, and the given set voltage is ΔV.

9. The circuit device according to claim 1, wherein
the control circuit obtains the voltage control data by arithmetic processing based on a set value of the given set voltage and the battery voltage data.

10. The circuit device according to claim 1, wherein
the linear regulator circuit includes
an operational amplifier including a non-inverting input terminal to which a reference voltage is input,
a transistor provided between an input node of an input voltage and an output node of the power supply voltage and including a gate to which an output voltage of the operational amplifier is input,
a variable resistance circuit provided between the output node of the power supply voltage and an inverting input terminal of the operational amplifier and whose resistance value is variably set based on the voltage control data, and
a resistor provided between the inverting input terminal of the operational amplifier and a ground node.

11. The circuit device according to claim 10, wherein
the variable resistance circuit includes
first to n-th resistors, n being an integer of 1 or more,
first to n-th transistor in which a j-th transistor is provided in parallel with a j-th resistor of the first to the n-th resistors and is controlled to be on or off by the voltage control data, j being an integer of 1 or more and n or less, and
an (n+1)-th resistor, and
a resistance value of the j-th resistor is k×2^{(j-1)}×R, a resistance value of the (n+1)-th resistor is (VA−VREF)×R, and a resistance value of the resistor is VREF×R, in which a step of the power supply voltage corresponding to an LSB of the voltage control data is k, a lower limit of the power supply voltage is VA, and R is any real number greater than 0.

12. The circuit device according to claim 10, further comprising:
a power reception circuit configured to receive power transmitted by contactless power transmission, wherein
a voltage received by the power reception circuit is input to the linear regulator circuit as the input voltage.

13. An electronic apparatus comprising:
the circuit device according to claim 1; and
the battery.
